(19) United States
(12) Patent Application Publication
(10) Pub. No.: US 2016/0150027 A1
(43) Pub. Date: May 26, 2016

(54) Method Of Handling Notification Channel Disconnection

(71) Applicant: Futurewei Technologies, Inc., Plano, TX (US)

(72) Inventors: Xinmin Ding, San Jose, CA (US); Huipeng Ren, Shenzhen (CN)

(21) Appl. No.: 14/553,545

(22) Filed: Nov. 25, 2014

(51) Int. Cl. H04L 29/08; H04L 12/26; G06F 17/30

(52) U.S. Cl. CPC H04L 67/143; G06F 17/30887; H04L 67/02; H04L 43/10

(57) ABSTRACT

A method of handling notification channel disconnection is provided. The method includes detecting that a notification channel corresponding to a representational state transfer (REST) client is disconnected, sending, to an application server, a disconnection request indicating that the notification channel is disconnected, and receiving, from the application server, a response indicating that a subscription of the REST client has been deleted.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Representational state transfer (REST) is an abstraction of the architecture of the World Wide Web. More precisely, REST is an architectural style including a coordinated set of architectural constraints applied to components, connectors, and data elements within a distributed hypermedia system. REST ignores the details of component implementation and protocol syntax in order to focus on the roles of components, the constraints upon their interaction with other components, and their interpretation of significant data elements.

The REST architectural style may be applied to the development of web services as an alternative to other distributed-computing specifications such as, for example, Simple Object Access protocol (SOAP). One can characterize web services as “RESTful” if they conform to certain architectural constraints involving or relating to a client-server model, a stateless protocol, a web cache, a layered system, code on demand (optional), and a uniform interface.

In some circumstances, the REST architectural style may be applied to web application programming interfaces (APIs). Web APIs that adhere to the architectural constraints are called RESTful.

### SUMMARY

In one embodiment, the disclosure includes a method of handling notification channel disconnection includes detecting a disconnection of a notification channel corresponding to a REST client, sending, to an application server, a disconnection request indicating that the notification channel is disconnected, and receiving, from the application server, a response indicating that a subscription of the REST client has been deleted.

In another embodiment, the disclosure includes a method of handling notification channel disconnection including receiving, from a notification server, a disconnection request indicating that a notification channel between the notification server and a REST client is disconnected, and sending, to the notification server, a response indicating that a subscription of the REST client has been deleted.

In yet another embodiment, the disclosure includes a notification server including a processor operably coupled to a memory, and a notification channel disconnection module stored in the memory that, when executed by the processor, is configured to detect that a notification channel corresponding to a REST client is disconnected, send, to an application server, a disconnection request indicating that the notification channel is disconnected, and receive, from the application server, a response indicating that a subscription of the REST client has been deleted.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is protocol diagram of a method of creating and deleting a notification channel and a subscription in a RESTful environment

FIG. 2 is protocol diagram of an embodiment of a notification channel disconnection method.

FIG. 3 is a schematic diagram of an embodiment of a computing device capable of facilitating the method of FIG. 3.

FIG. 4 is a flowchart of an embodiment of a method of handling a notification channel disconnection.

FIG. 5 is a flowchart of an embodiment of a method of handling a notification channel disconnection.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for handling notification channel disconnection. As will be more fully explained below, the system and methods disclosed herein permit a notification server to notify an application server when a notification channel has been disconnected. Because the application server is kept up-to-date on the current status of the notification channel, any subscriptions binding to the notification channel may be deleted by the application server when the notification channel suffers a disconnection.

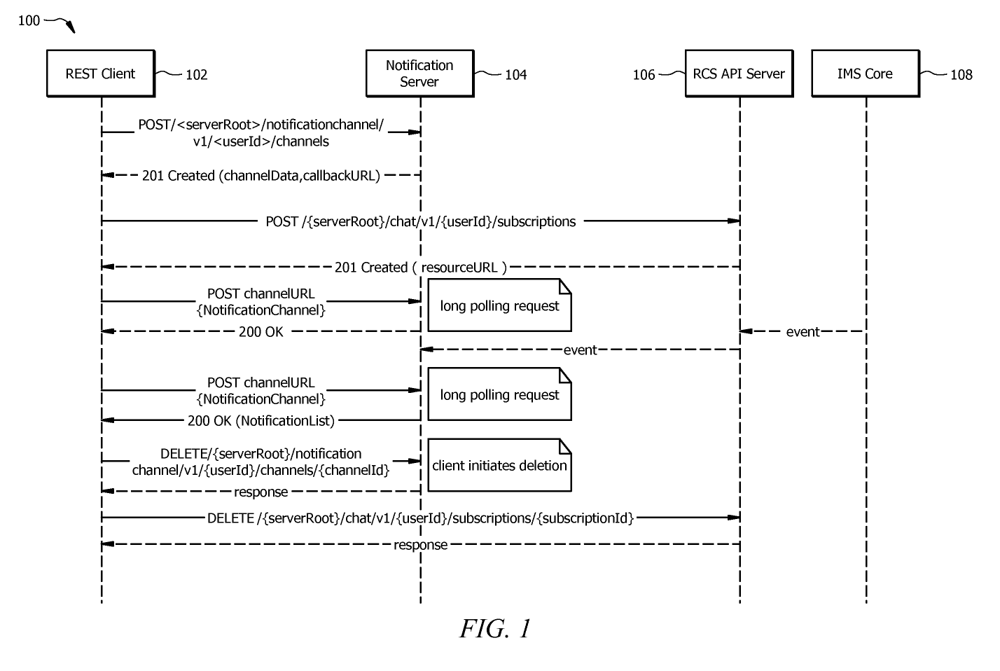

FIG. 1 is protocol diagram of a method 100 of creating and deleting a notification channel and a subscription in a RESTful environment. The creation, deletion, and use of the notification channel using a REST architecture and API are described in more detail in the RESTful Network API for Notification Channel, Candidate Version 1.0, specification published Jul. 30, 2013, which is incorporated herein by reference as if reproduced in their entirety.

The method 100 of FIG. 1 is illustrated in the context of a computing device, which for convenience will be referred to herein a client 102, a notification server 104, an API server 106, and a core server 108. The client 102 may be a personal computer (PC), a mobile device (e.g., smart phone, tablet computer, etc.). Each client 102 includes one or more APIs used to handle a web application. By way of example, the web application may be a web application used to make video calls (e.g., Microsoft Skype™) or to otherwise facilitate communication between clients 102.

Each client 102 includes a browser (e.g., Mozilla Firefox®, Google Chrome®, Microsoft Internet Explorer®, or Apple Safari®). As well known in the art, a browser is a software application for retrieving, presenting, and traversing information resources on the World Wide Web. Some web browsers utilize a technology referred to a Web Real-Time Communications (WebRTC). WebRTC is an API drafted by the Worldwide Web Consortium (W3C) that supports browser-to-browser application for video-calling, video chat, peer-to-peer (P2P) file sharing, and the like, without requiring a plugin in the browser. If the browser of each client 102 includes support for WebRTC, the clients 102 may engage in browser-to-browser communications without the need for a plugin.

As shown in FIG. 1, the client 102 is configured to communicate with the notification server 104 and the API server 106. In one embodiment, the API server 106 is a Rich Communication Suite (RCS) API server. In some embodiments, one or both of the notification server 104 and the API server 106 are a WebRTC user network interface (UNI) server. The API server 106 is configured to communicate with the core server 108. In one embodiment, the core server 108 is an Internet Protocol (IP) Multimedia Subsystem or an IP Multimedia Core Network Subsystem (IMS).

As shown in FIG. 1, the creation of a notification channel begins when the client 102 (e.g., running an application) sends a notification channel request to the notification server 104. In some embodiments, the notification channel request is in a Hypertext Transfer Protocol (HTTP) format. For example, the notification channel request may be implemented using the HTTP POST operation as described in the Internet Engineering Task Force (IETF) document, Hypertext Transfer Protocol (HTTP/1.1): Semantics and Content, draft-ietf-httpbis-p2-semantics-26, published Feb. 6, 2014, and the Request for Comments (RFC) document, Hypertext Transfer Protocol (HTTP/1.1): Semantics and Content, RFC 7231, published June 2014, both of which are incorporated herein by reference as if reproduced in their entirety.

When the notification channel request is received, the notification server 104 creates the notification channel. The notification server 104 then sends a response back to the client 102 to advise the client 102 that the notification channel has been established. In some embodiments, the response back to the client 102 includes channel information such as channel data, a callback Uniform Resource Locator (URL), and a channel URL.

The client 102 then sends a subscription request to the API server 106. The subscription request may be, for example, a chat notification subscription, a file transfer notification subscription, and so on. The subscription request includes, for example, the callback URL. In some embodiments, the subscription request is in an HTTP format. For example, the subscription request may be implemented using the HTTP POST operation. When the subscription request is received, the API server 106 creates the subscription. The API server 106 then sends a response back to the client 102 to advise the client 102 that the subscription has been established. The response back to the client 102 may include a resource URL.

In some embodiments, the client 102 and the notification server 104 are configured to utilize HTTP long polling (e.g., a long polling protocol) such that a “heartbeat” exists between the client 102 and the notification server 104. In other words, continual two-way communications exist between the notification server 104 and the client 102. In some embodiments, other two way communications are established such as, for example, Bidirectional-streams Over Synchronous HTTP (BOSH), asynchronous JavaScript+Extensible Markup Language (XML) (AJAX), and so on.

To initiate the long polling process, the client 102 sends a long polling request to the notification server 104. The long polling request includes, for example, the channel URL. In some embodiments, the long polling request is in an HTTP format. For example, the long polling request may be implemented using the HTTP POST operation. When the long polling request is received, the notification server 104 sends a response back to the client 102 to advise the client 102 that long polling has been established.

The client 102 initiates a new long polling request in order to obtain subsequent events. If, for example, the long polling request times out before a complete response is sent to the client 102, the notification server 104 may send a timeout response back to the client 102. This circumstance may occur when, for example, the notification server 104 takes too long to respond to a request for information or data from the client 102. After receiving the timeout response, the client 102 may immediately make another long polling request to keep the communication channel between the client 102 and the notification server 104 active or open.

Still referring to FIG. 1, when the API server 106 receives an event notification from the core server 108, the API server 106 sends the event notification to the notification server 104. When the notification server 104 receives the next long polling request from the client 102, the notification server 104 includes the event notification in the long polling response to the client 102. For example, the notification server sends a notification list including the event in the response to the client 102.

When the client 102 desires to delete the notification channel, the client sends a delete notification channel request to the notification server. In some embodiments, the delete notification channel request is in an HTTP format. For example, the delete notification channel request may be implemented using the HTTP DELETE operation as described in the IETF document, Hypertext Transfer Protocol (HTTP/1.1): Semantics and Content, draft-ietf-httpbis-p2-semantics-26, published Feb. 6, 2014, and the RFC document, Hypertext Transfer Protocol (HTTP/1.1): Semantics and Content, RFC 7231, published June 2014, both of which are incorporated herein by reference as if reproduced in their entirety.

When the delete notification channel request is received, the notification server 104 deletes the notification channel. The notification server 104 then sends a response back to the client 102 to advise the client 102 that the notification channel has been deleted. The client 102 then sends a subscription delete request to the API server 106. In some embodiments, the subscription delete request is in an HTTP format. For example, the subscription delete request may be implemented using the HTTP DELETE operation. When the subscription delete request is received, the API server 106 deletes the subscription. The API server 106 then sends a response back to the client 102 to advise the client 102 that the subscription has been deleted.

Unfortunately, the above process for creating and deleting a notification channel and subscriptions does not define any processing for when a notification channel is disconnected. Indeed, when the notification server 104 detects that the notification channel between the notification server 104 and the client 102 has been disrupted, the notification server 104 has no way to notify the API server 106. As such, the API server 106 has no way to delete the subscriptions.

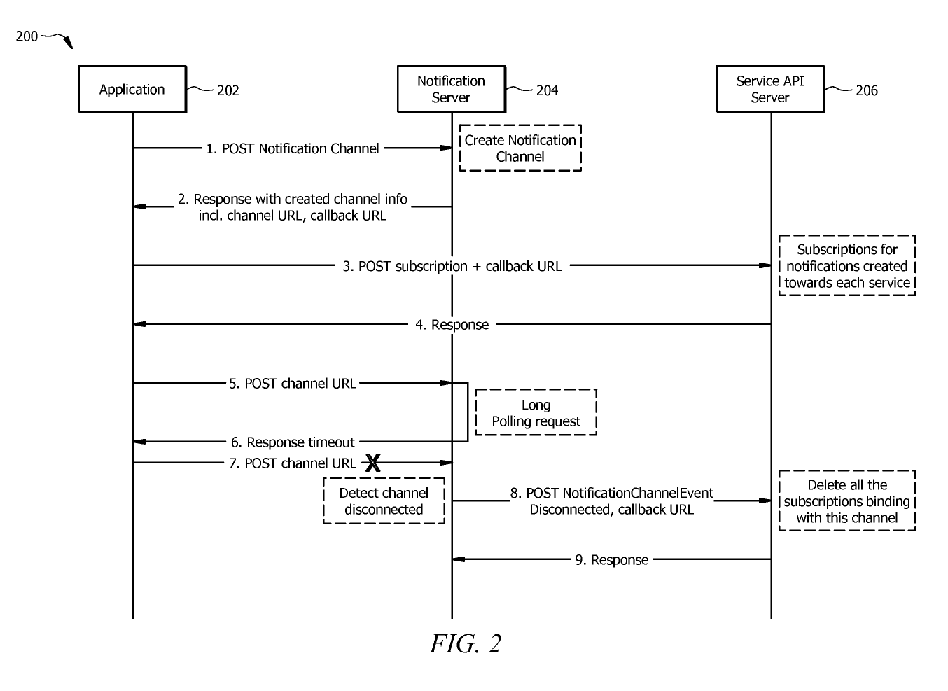

FIG. 2 is protocol diagram of an embodiment of a notification channel disconnection method 200 that solves the foregoing problems. The method 200 is employed when the notification channel is disconnected or otherwise disrupted, either temporarily or permanently. The method 200 is implemented using a client 202 (e.g., running an application), a notification server 204, and an API server 206. In some embodiments, the client 202, the notification server 204, and the API server 206 are configured similar to the client 102, the notification server 104, and the API server 106 in FIG. 1.

The process of creating the notification channel, requesting the subscription, and setting up the long polling between the client 202 and the notification server 204 shown in FIG. 2 are similar to or the same as those processes described in connection with FIG. 1. For the sake of brevity, a full description of those processes is intentionally not repeated herein.

After long polling between the client 202 and the notification server 204 has been established as shown in FIG. 2, the notification channel may become undesirably disconnected. Should this occur, any long polling communication sent by the client 202 to the notification server 204 will fail, as shown by the ‘X’ on the polling request in FIG. 2.

The notification server 204 is able to detect a failure or disconnection of the notification channel. In some embodiments, the notification server 204 determines that the notification channel has failed when the “heart beat” of the long polling process is no longer felt or has ceased. In some embodiments, the notification server 204 determines that the notification channel is disconnected after no communication is received from the client 202 for a predetermined amount of time.

When a disconnection of the notification channel has been detected, the notification server 204 sends a disconnection request to the API server 206. The request indicates to the API server 206 that the notification channel between the client 202 and the notification channel 204 is disconnected. In some embodiments, the disconnection request includes a callback URL and an identification of a user (e.g., user ID) of the application running on the client 202. In some embodiments, the disconnection request is in an HTTP format. For example, the disconnection request may be implemented using the HTTP POST operation.

When the disconnection request is received, the API server 206 deletes the subscriptions corresponding to the client 202. For example, the API server 206 deletes the subscriptions in accordance with the user ID and the callback URL received from the notification server 204. The API server 206 then sends a response back to the notification server 204. The response indicates that the subscriptions pertaining to the client 202 (e.g., the subscriptions corresponding to the user ID and/or the callback URL) have been deleted. By deleting the subscriptions for the client 202 when the notification channel between the client 202 and the notification server 204 has been disconnected, invalid subscriptions for service notifications are prevented. In other words, the invalid resource is removed.

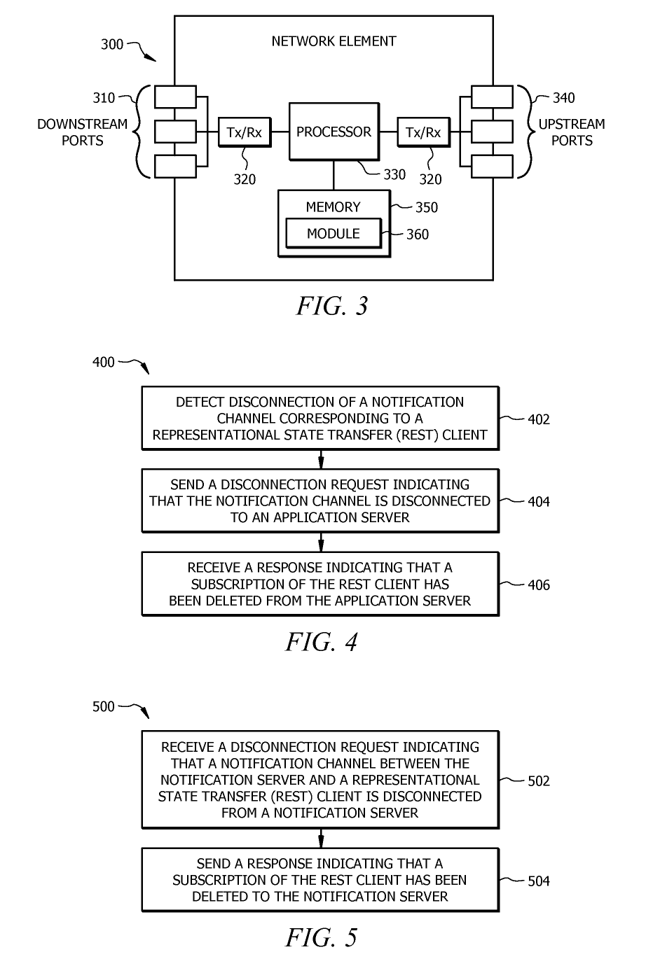

FIG. 3 is a schematic diagram of an embodiment of a server 300 used to send and receive messages or information through at least a portion of the system shown in FIGS. 1-2. At least some of the features/methods described in the disclosure may be implemented in the server 300. For instance, the features/methods of the disclosure may be implemented in hardware, firmware, and/or software installed to run on the hardware. The server 300 may be any device that transports data through a network, system, and/or domain. Moreover, the term server, computer, logic device, and/or similar terms may be interchangeably used to generally describe a server and do not have a particular or special meaning unless otherwise specifically stated and/or claimed within the disclosure.

In one embodiment, the server 300 may be an apparatus configured to participate in the handling of notification channel disconnection depicted in FIG. 2. In addition, components or functions of the server 300 may be implemented in and/or integrated within the client 202, the notification sever 204, and the API server 206, or devices in the core network 108 as described and illustrated in FIGS. 1-2.

The server 300 may comprise one or more downstream ports 310 coupled to a transceiver (Tx/Rx) 320, which may be transmitters, receivers, or combinations thereof. The Tx/Rx 320 may transmit and/or receive messages or information from other network devices (e.g., servers, etc.) via the downstream ports 310. Similarly, the server 300 may comprise another Tx/Rx 320 coupled to a plurality of upstream ports 340, wherein the Tx/Rx 320 may transmit and/or receive messages or information from other network devices via the upstream ports 340. The downstream ports 310 and/or the upstream ports 340 may include electrical and/or optical transmitting and/or receiving components.

A processor 330 may be coupled to the Tx/Rx 320 and may be configured to process the messages or information and/or determine which servers to send (e.g., transmit) the messages or information to. In an embodiment, the processor 330 may comprise one or more multi-core processors and/or memory modules 350, which may function as data stores, buffers, etc. The processor 330 may be implemented as a general processor or may be part of one or more application specific integrated circuits (ASICs), field-programmable gate arrays (FPGAs), and/or digital signal processors (DSPs). Although illustrated as a single processor, the processor 330 is not so limited and may comprise multiple processors. The processor 330 may be configured to the adaptive and dynamic allocation of media resources described herein.

FIG. 3 illustrates that a memory 350 may be coupled to the processor 330 and may be a non-transitory medium configured to store various types of data. Memory 350 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory 350 may be used to house the instructions for carrying out the various example embodiments described herein. In one example embodiment, the memory 350 may comprise a module 360. In an embodiment, the module 360 represents a notification channel disconnection module disposed within the notification server 204 and/or the API server 206 as shown in FIG. 2. The module 360 is capable of implementing notification channel disconnection processes and permitting the notification server 204 and the API server 206 to exchange messages. In other words, the module 360 permits the notification server 204 and the API server 206 to communicate with each other regarding, for example, a disconnection of the notification channel between the client 202 and the notification server 204.

It is understood that by programming and/or loading executable instructions onto the server 300, at least one of the processor 330, the cache, and the long-term storage are changed, transforming the server 300 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

FIG. 4 is a flowchart of an embodiment of a method 400 of handling a notification channel disconnection. In an embodiment, the instructions for executing the method 400 are stored in notification channel disconnection module 360 and the method 400 is implemented using processor 330. The method 400 is implemented when the notification channel between the client 202 and the notification server 204 is disconnected to inform the API server 206 that the notification channel between the client 202 and the notification server 204 is disconnected so that subscriptions relating to the client 202 can be deleted.

In block 402, a disconnection of a notification channel corresponding to a REST client is detected. In an embodiment, the notification server 204 of FIG. 2 is able to detect a failure or disconnection of the notification channel. In some embodiments, the notification server 204 determines that the notification channel has failed when the “heart beat” of the long polling process is no longer felt or has ceased. In some embodiments, the notification server 204 determines that the notification channel is disconnected after no communication is received from the client 202 for a predetermined amount of time.

In block 404, a disconnection request indicating that the notification channel is disconnected is sent to an application server. In an embodiment, when a disconnection of the notification channel has been detected, the notification server 204 of FIG. 2 sends the disconnection request to the API server 206. The request indicates to the API server 206 that the notification channel between the client 202 and the notification channel 204 is disconnected. In some embodiments, the disconnection request includes a callback URL and an identification of a user (e.g., user ID) of the application running on the client 202. In some embodiments, the disconnection request is in an HTTP format. For example, the disconnection request may be implemented using the HTTP POST operation.

In block 406, a response indicating that a subscription of the REST client has been deleted is received from the application server. In an embodiment, when the disconnection request is received, the API server 206 of FIG. 2 deletes the subscriptions corresponding to the client 202. For example, the API server 206 deletes the subscriptions in accordance with the user ID and the callback URL received from the notification server 204. The API server 206 then sends a response back to the notification server 204. In an embodiment, the response indicates that the subscriptions pertaining to the client 202 (e.g., the subscriptions corresponding to the user ID and/or the callback URL) have been deleted. By deleting the subscriptions for the client 202 when the notification channel between the client 202 and the notification server 204 has been disconnected, invalid subscriptions for service notifications are prevented. In other words, the invalid resource is removed.

FIG. 5 is a flowchart of an embodiment of a method 500 of handling a notification channel disconnection. In an embodiment, the instructions for executing the method 500 are stored in notification channel disconnection module 360 and the method 500 is implemented using processor 330. The method 500 is implemented when the notification channel between the client 202 and the notification server 204 is disconnected to inform the API server 206 that the notification channel between the client 202 and the notification server 204 is disconnected so that subscriptions relating to the client 202 can be deleted.

In block 502, a disconnection request indicating that a notification channel between the notification server and a REST client is disconnected is received from a notification server. In an embodiment, the notification server 204 of FIG. 2 is able to detect a failure or disconnection of the notification channel. In some embodiments, the notification server 204 determines that the notification channel has failed when the “heart beat” of the long polling process is no longer felt or has ceased. In some embodiments, the notification server 204 determines that the notification channel is disconnected after no communication is received from the client 202 for a predetermined amount of time. In an embodiment, when a disconnection of the notification channel has been detected, the notification server 204 of FIG. 2 sends the disconnection request to the API server 206. The request indicates to the API server 206 that the notification channel between the client 202 and the notification channel 204 is disconnected. In some embodiments, the disconnection request includes a callback URL and an identification of a user (e.g., user ID) of the application running on the client 202. In some embodiments, the disconnection request is in an HTTP format. For example, the disconnection request may be implemented using the HTTP POST operation.

In block 504, a response indicating that a subscription of the REST client has been deleted is sent to the notification server. In an embodiment, when the disconnection request is received, the API server 206 of FIG. 2 deletes the subscriptions corresponding to the client 202. For example, the API server 206 deletes the subscriptions in accordance with the user ID and the callback URL received from the notification server 204. The API server 206 then sends a response back to the notification server 204. In an embodiment, the response indicates that the subscriptions pertaining to the client 202 (e.g., the subscriptions corresponding to the user ID and/or the callback URL) have been deleted. By deleting the subscriptions for the client 202 when the notification channel between the client 202 and the notification server 204 has been disconnected, invalid subscriptions for service notifications are prevented. In other words, the invalid resource is removed.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. A method of handling notification channel disconnection, comprising:
detecting a disconnection of a notification channel corresponding to a representational state transfer (REST) client;
sending, to an application server, a disconnection request indicating that the notification channel is disconnected; and
receiving, from the application server, a response indicating that a subscription of the REST client has been deleted.

2. The method of claim 1, wherein the disconnection request includes an identification of a user of an application running on the REST client and a callback uniform resource locator (URL).

3. The method of claim 2, wherein the response from the application server indicates that the subscription corresponding to the identification of the user and the callback URL has been deleted.

4. The method of claim 1, wherein the response from the application server indicates that the subscription corresponding to an identification of a user of an application running on the REST client and a callback URL has been deleted.

5. The method of claim 1, wherein disconnection of the notification channel is detected based on a cessation of long polling communications.

6. The method of claim 1, wherein disconnection of the notification channel is detected based on a lack of communication from the REST client for a predetermined amount of time.

7. The method of claim 1, wherein the disconnection request is in a Hypertext Transfer Protocol (HTTP) format.

8. The method of claim 1, wherein the disconnection request in implemented in a Hypertext Transfer Protocol (HTTP) POST message.

9. The method of claim 1, wherein the subscription is one of a chat notification subscription and a file transfer notification subscription.

10. A method of handling notification channel disconnection, comprising:
receiving, from a notification server, a disconnection request indicating that a notification channel between the notification server and a representational state transfer (REST) client is disconnected; and
sending, to the notification server, a response indicating that a subscription of the REST client has been deleted.

11. The method of claim 10, wherein the disconnection request includes an identification of a user of an application running on the REST client AND a callback uniform resource locator (URL).

12. The method of claim 11, wherein the response indicates that the subscription corresponding to the identification of the user AND the callback URL has been deleted.

13. The method of claim 10, wherein the disconnection request includes an identification of a user of an application running on the REST client and a callback uniform resource locator (URL), and wherein the response indicates that the subscription corresponding to the identification of the user and the callback URL has been deleted.

14. The method of claim 10, wherein the disconnection request is based upon a cessation of long polling communications between the notification server and the REST client.

15. The method of claim 10, wherein the disconnection request is based upon a lack of communications between the notification server and the REST client for a predetermined amount of time.

16. The method of claim 10, wherein the disconnection request in implemented in a Hypertext Transfer Protocol (HTTP) POST message.

17. A notification server, comprising:
a processor operably coupled to a memory; and
a notification channel disconnection module stored in the memory that, when executed by the processor, is configured to:
detect that a notification channel corresponding to a representational state transfer (REST) client is disconnected;
send, to an application server, a disconnection request indicating that the notification channel is disconnected; and
receive, from the application server, a response indicating that a subscription of the REST client has been deleted.

18. The notification server of claim 17, wherein the disconnection request includes an identification of a user of an application running on the REST client and a callback uniform resource locator (URL), and wherein the response from the application server indicates that the subscription corresponding to the identification of the user and the callback URL has been deleted.

19. The notification server of claim 18, wherein the response from the application server indicates that the subscription corresponding to an identification of a user of an application running on the REST client and a callback URL has been deleted.

20. The notification server of claim 19, wherein disconnection of the notification channel is detected based on one of a cessation of long polling communications and a lack of communication from the REST client for a predetermined amount of time.
